(19) United States
(12) Patent Application Publication
(10) Pub. No.: US 2005/0203848 A1
(43) Pub. Date: Sep. 15, 2005

(54) Testing content in a conditional access system

(76) Inventors: Sebastiaan Antonius Fransiscus Arnoldus Van De Heuvel, Eindhoven (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,215

(22) PCT Filed: Apr. 1, 2003
(86) PCT No.: PCT/IB03/01313

§ 371 Date: Oct. 13, 2004

(30) Foreign Application Priority Data
Apr. 18, 2002 (EP) 02076521.0

(51) Int. Cl. G06F 17/60

(52) U.S. Cl. 705/51; 705/1; 705/18

(57) ABSTRACT

A method of providing conditional access to a content item, which content item is protected by a particular security mechanism, comprising providing unconditional access to a sample content item (105) protected by the same particular security mechanism. The sample content item (105) could be e.g. a trailer for the content item (104). Preferably the protected content item (104) is formatted using a particular formatting scheme like MPEG-2, and the sample content item (105) is formatted using the same formatting scheme. If acquisition of rights by a client (120) is necessary for playback of the content item (104), this is preferably refused until the sample content item (105) has been accessed by said client (120).

The invention relates to a method of providing conditional access to a content item, which content item is protected by a particular security mechanism.

The best thing about standards is that there are so many to choose from. In today's digital world, this is particularly true when content distribution is involved. The term “content” or “content item” is used here to denote digital objects containing music, songs, movies, TV programs, pictures and other types of binary data, but also textual data. It is to be noted that a content item may be made up of several different files. Many different formatting schemes (for example, MP3 for music, or MPEG-2 for movies) have been developed to allow efficient distribution of content items. These typically try to reduce the size of content item to be distributed whilst retaining the original quality.

At the same time many different security mechanisms have been developed to protect against unauthorized access and/or copying of content items. Such security mechanisms often involve the acquisition of digital rights which are necessary by a playback device before it can play back a received content item. Such acquisition in turn often involves the making of a payment.

Additionally, once digital rights have been purchased, a user is often permitted to make a limited number of copies of the content item, and/or to transfer the content item to different devices within a single domain (see e.g. European patent application 01204668.6, attorney docket PHNL010880). The security mechanism that controls the making of said limited number of copies, or the transfer of content between devices is not necessarily the same security mechanism as was used to obtain the content item in the first place. In fact, there may be as many different security mechanisms involved as there are devices within the domain. The various security systems implementing those mechanisms then need to be compatible with each other. The number of security systems may even be more than the number of devices.

It is clear that the high number of different security mechanisms involved in the transfer of content from a content distributor to a playback device can easily weaken the entire system. If two different mechanisms are not completely compatible, the user may be able to view the content item on one particular playback device, but not on another. This could happen, for example, if the digital rights purchased by the user are transferred incorrectly from one device to another, or if one security mechanism between content distributor and playback device does not support a particular digital right purchased by the user, and so fails to pass along this digital right to the next link in the chain. These systems and conversions can be located both inside and outside the home.

This problem only increases if different formatting schemes are used by different devices. If a content item is transferred from a content distributor in format A and protected using security mechanism X, and on the way to the playback device it gets transcoded to format B and then to formats C and D, as well as transferred to security systems Y and Z, the chances that the user will be able to successfully play back the content item will be reduced substantially. Translating between formatting schemes and security mechanisms may negatively affect the quality of the content item.

Further, the playback device on which the user wants to play back the content item might not even support the formatting scheme and/or security mechanism in which the content item is provided. Ordinarily, the user would find out about this only after purchasing the necessary rights and subsequently trying to initiate playback. The user has now paid for something which he cannot use, which is clearly undesirable.

It is an object of the invention to provide a method according to the preamble, which reduces the risk that a user purchases a content item which he is unable to play back.

This object is achieved according to the invention in a method comprising providing unconditional access to a sample content item protected by the same particular security mechanism. The sample content item could, for instance, comprises a trailer or advertisement for the content item, or represent a part of the content item. By downloading and playing the thusly provided sample, the user can test the operation of his system. As it is protected by the same security mechanism as the “real” content item desired by the user, the sample will undergo the same type of conversions as the real content item on the way from content distributor to playback device. Any errors that might occur because of incompatibilities in the various security mechanisms involved will then show up during the playback of the sample.

When the sample content item has been successfully passed through the system and can be rendered (with sufficient quality as judged by the user), the user has some assurance that the content he wants to buy can actually be rendered by his system. He can then initiate the necessary procedures, such as acquiring (often by purchasing) one or more digital rights, to obtain a specimen of the “real” content item, for which conditional access is provided. Note that the user does not have to pay or otherwise seek permission to obtain the sample, as it is provided unconditionally. Thus, if it fails to render successfully, the user is not negatively affected financially.

In an embodiment the protected content item is formatted using a particular formatting scheme, and the sample content item is formatted using the same formatting scheme. This way, the user can test not only whether the various security mechanisms involved are compatible and do not negatively affect the content item, but also whether the transcoding procedures between the various formatting schemes would affect the content item.

In a further embodiment the access to the content item is conditional upon acquisition of one or more rights. The necessity to obtain digital rights can be exploited in various ways to even further reduce the risk that a user purchases a content item which he is unable to play back.

For example, the acquisition of said one or more rights by a client is refused until the sample content item has been accessed by said client. This way, the user is forced to first test the operation of his client system, as a reasonable precaution. This should minimize the risk that the user purchases or otherwise acquires a digital right and subsequently finds himself unable to make proper use of it.

Alternatively, the sample content item comprises an information element necessary for the acquisition of said one or more rights. This could be simply a code word that the user needs to supply to the digital rights management server during the acquisition process. Supplying the code word then serves as proof that the user was able to successfully play back the sample.

A similar approach would that the man-machine interface session with the user that allows the conditional access system to communicate with the user is protected using the same security mechanism as the content item.

In a further embodiment the content item is protected by an encryption scheme using a particular key, and the sample content item is protected by the same encryption scheme using the same particular key. In this fashion no new key needs to be transferred after a successful test. Such a key transfer could fail, leading to the unwanted result that the user is unable to play back the real content item after a successful test.

In a further embodiment access to the content item and the sample content item is provided using a content resolution protocol wherein the content item and the sample content item have a common content resolution identifier. An example of such a content resolution identifier is the CRID as used by the TV-Anytime consortium. This makes it very easy for the user to locate both the real content item and the sample.

It is a further object of the invention to provide a sample content item for use with the method according to the invention. In an embodiment, there is provided a sample content item associated with a content item protected by a particular security mechanism, access to the content item being conditional upon acquisition of one or more rights, the sample content item being protected by the same particular security mechanism, and comprising an information element necessary for the acquisition of said one or more rights.

These and other aspects of the invention will be apparent from and elucidated with reference to the embodiments shown in the drawings, in which:

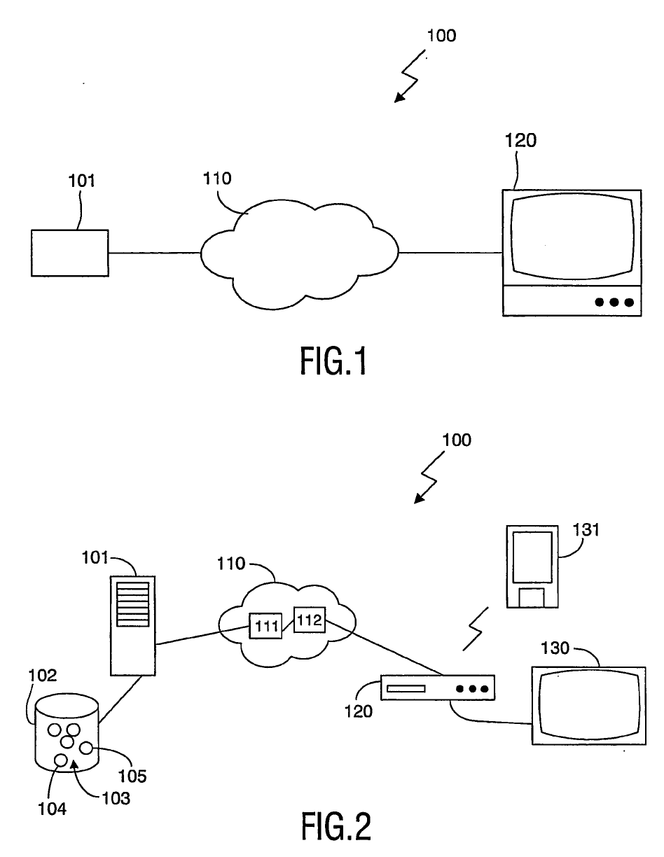

FIG. 1 schematically shows a first embodiment of an arrangement according to the invention; and

FIG. 2 schematically shows a second embodiment of the arrangement.

Throughout the figures same reference numerals indicate similar or corresponding features. Some of the features indicated in the drawings are typically implemented in software, and as such represent software entities such as software modules or objects.

FIG. 1 schematically shows an arrangement 100 comprising a distributing server 101 and a receiving device 120 connected via a network 110 such as the Internet or a cable television network. Using the network 110 the distributing server 101 can provide content items to the receiving device 120, for example by allowing the user of the receiving device 120 to access a subscription-based television service. The receiving device 120 can take many forms such as a set-top box, a television, a radio, a personal computer and so on.

The distributing server 101 can provide the service in many ways. In some cases the service provider broadcasts the encrypted service to all receiving devices which are connected via the network and only receiving devices having the appropriate descrambling means can descramble and access the service. In other cases, the distributing server 101 only provides instances of the service, such as a specific movie or television program to a specific subscriber who has asked for it.

The exact way in which a content item is rendered or played back by the receiving device 120 depends on the type of device and the type of content. For instance, in a radio receiver, rendering comprises generating audio signals and feeding them to loudspeakers. For a television receiver, rendering comprises generating audio and video signals and feeding those to a display screen and loudspeakers. For other types of content, such as interactive applications, a similar appropriate action must be taken. Rendering may also include operations such as decrypting or descrambling a received signal, synchronizing audio and video signals and so on.

Typically the user of a receiving device 120 should only be able to access the content if he is allowed to access it, e.g. by paying for it. Other models than payment can also be used to obtain access to the content item. For example, a user may receive credits for watch certain advertisements, and exchange those credits for access rights.

In order to restrict access, the distributing server 101 encrypts the content items that he distributes to the receiving device 120. The user of the receiving device 120 must then obtain the appropriate control words necessary to decrypt the service. There are many ways in which the distribution of control words to the users can be facilitated. The control word can be stored in the receiving device 120 or it may be distributed by the distributing server 101 to the receiving device 120 upon a payment from the user. The control word can be distributed via the network 110 or be stored on a smart card which the user can insert in the receiving device 120.

If the control word is stored in the receiving device 120 authorization must be sent by the distributing server 101 to the receiving device so that it will use the control word to access the service. If no authorization is received the receiving device must refuse to decrypt the service. Upon receipt of a valid authorization for accessing the service the device uses the control word to provide the user access to the service. If the control word is not available in the receiving device 120 itself, and not made available on a smartcard either, the distributing server 101 must send the control word to the receiving device 120.

FIG. 2 schematically shows a second embodiment of the arrangement 100. While in theory the arrangement 100 as shown in FIG. 1 is adequate for securely distributing content, in practice the situation is much more complex. Often the receiving device 120 is not a standalone apparatus, but part of a home network of some kind. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others, although this does not always have to be the case.

Content items 103 are loaded from a storage system 102, such as a file server, and transmitted to the distributing server 101. They could also be obtained from an external source. When a user requests a particular content item 104, the distributing server 101 obtains a copy from the storage system 102 and formats and encodes it for transmission over the network 110. This step preferably involves encrypting the content item 104 so that only the receiving device 120 can decrypt it.

Next, the content item 104 is transported over the network 110. In practice, this means it is received and passed on by several servers 111, 112 who may or may not modify the encoding and/or formatting of the content item 104. For example, server 111 may convert the content item 104 to analog signals that are then transmitted via a satellite link to server 112. Server 112 in turn converts the content item 104 back to digital information and subsequently encapsulates the content item 104 into Internet Protocol (IP) packets, which are then transmitted over the Internet to receiving device 120.

The receiving device 120, which in this embodiment is a set-top box or residential gateway, receives the IP packets and reconstructs the content item 104. It then decrypts the content item 104 and passes it on to a playback device such as television 130 or handheld display 131. Alternatively, the receiving device 120 could store a copy of the content item 104 on a storage medium (not shown) such as a hard disk or DVD+RW.

When transmitting the content item 104 to a playback device, care must be taken to ensure that no unauthorized copies can be made of it. To do this, a security framework, typically referred to as a Digital Rights Management (DRM) system is necessary.

In one such framework, the home network is divided conceptually in a conditional access (CA) domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in European patent application 01204668.6 (attorney docket PHNL010880) by the same applicant as the present application.

The home network will often be much more complex than shown in FIG. 2. For instance, a variety of devices could be necessary to transport the content item 104 from the receiving device 120 and the handheld display 131. The home network may comprise a multitude of domains, each with their own restrictions and rules, making it necessary to convert the content item 104 whenever it enters or leaves a particular domain. In this process, some of the digital rights obtained by the user may get lost due to incompatibilities between the domains. For instance, a right to view the content item 104 three times cannot be handled by a basic copy protection domain.

Additionally, the playback device 130, 131 to which the content item 104 is transported may not even be able to render the content item 104 at all. The handheld display 131 might, for example, not have the necessary software installed to play back content formatted in accordance with the MPEG-4 standard. The only way for the user to find out is to obtain a copy of the content item 104, have it transferred to the handheld display 131 and see if it works.

Obviously, this is not acceptable when the user has to spend money to acquire one or more rights necessary to decrypt or otherwise access the content item 104. To this end, in the present invention a sample content item 105 is provided in the same fashion as the content item 104 which the user desires. That is, it is protected by the same protection or digital rights management system as the content item 104.

Access to the sample content item 105 is unconditional, in the sense that the user does not have to spend money or otherwise obtain permission to obtain the sample content item 105. This way, he can simply test the correct working of the entire arrangement 100 by obtaining the sample content item 105 and seeing whether it is played back correctly on the playback device of his choice. If, for example, the sample content item 105 is formatted in accordance with a scheme not supported by the handheld display 131, the user will get an error message, and he then knows he should not attempt to acquire the content item 104.

Preferably the sample content item 105 comprises a trailer for the content item 104. It could also be a (short) part of the content item 104 itself, a short promotional message regarding the content item 104 or regarding the service provider who makes the content item 104 available, and so on.

The content item 104 may be protected by an encryption scheme using a particular key. The sample content item 105 should then be protected by the same encryption scheme using the same particular key. In this fashion no new key needs to be transferred after a successful test. Such a key transfer could fail, leading to the unwanted result that the user is unable to play back the real content item after a successful test.

The content item 104 is formatted using a particular formatting scheme, such as MPEG-2. Preferably, then, the sample content item 105 is formatted using the same formatting scheme. In the distribution chain between the file server 102 and the playback device 130 or 131, the content item 104 may be reformatted in accordance with another formatting scheme. This is not always done correctly, for example because some formatting option used in the original formatting scheme is not supported by the target formatting scheme.

By formatting the sample content item 105 with the same original formatting scheme, the user can test not only whether the various security mechanisms involved are compatible and do not negatively affect the content item, but also whether the transcoding procedures between the various formatting schemes would affect the content item.

When access to the content item 104 is conditional upon acquisition of one or more rights, it is desirable that the user does not attempt to acquire such rights until he has verified that he will be able to play back the content item 104. So, preferably the acquisition of said one or more rights is refused until the sample content item 105 has been accessed by said client. This can easily be detected by the distributing server 101 if the identity of the user, or an identifier for the receiving device 120 (which typically requests the rights) can be obtained.

Another way to prevent the acquisition of rights which the user will be unable to use is to embed an information element necessary for the acquisition of said one or more rights in the sample content item 105. This could be simply a code word that the user needs to supply to the distributing server 101 during the acquisition process. Supplying the code word then serves as proof that the user was able to successfully play back the sample.

The best results are obtained when the content item 104 and the sample content item 105 are provided by the distributing server 101 linked to each other. This way, the user is less likely to oversee the fact that a sample is available using which he can freely test the arrangement 100. This could be realized e.g. by storing the content item 104 and the sample content item 105 on the same carrier, if the distributing server 101 makes content available in this fashion. They can also be made available from the same webserver, or by providing links to the respective content items 104, 105 from a single webpage.

Using e.g. DVB-MHP or information in an Electronic Program Guide (EPG), the content item 104 and the sample content item 105 can also be logically linked. In particular, when using the TV-Anytime CRID resolution process a logical link can be established very easily.

In this process, metadata for the content items 103 generally comprises information such as title, artist, genre and so on, and may also contain a unique content reference identifier (CRID), sometimes also called a content reference identifier. Using the CRID, each individual content item can be uniquely identified. Further, using the CRID further information can be retrieved from a database. For example, a user can select a content item which he wishes to see from the EPG, even though the time and place of broadcast are not yet known. Using the CRID, the system can then retrieve the time and place of broadcast of the content item when this information becomes available.

The CRID is not restricted to broadcast transmissions of content. It could also refer to a location on the Internet, or to any other source. The purpose of content resolution is to allow acquisition of a specific instance of a specific item of content. For example a user may want to record an episode of a television series, but he does not necessarily know when and where that episode will become available. He can then use his personal digital recorder (PDR) or similar device to enter a reference to the episode or series by means of the CRID. Note that a CRID may refer to an entire series or to an individual episode thereof.

Having received a CRID for a content item, the PDR tries to obtain the location of the content item. This information is called a locator and it contains the date, time and channel on which the content item will be broadcast. The user however does not need to be aware of this. Once the PDR has obtained the locator of the content item, the PDR waits for the specified date and time and then records the episode as it is broadcast on the specified channel. Of course, if the locator indicates a location on the Internet or the like, the PDR can simply retrieve the content from the indicated location as soon as it becomes available.

The TV-Anytime standardization body provides a standardized Content Reference ID. See TV-Anytime Forum, www.tv-anytime.org, Specification Series: S-4, on Content Referencing (Normative), Document SP004V11, Apr. 14, 2001. The CRID is used for location resolution, which can be defined as the process of translating a CRID into other CRID(s) or locators. For instance, a CRID for an entire TV series could be translated into a series of CRIDs for the individual episodes of that series. Location resolution may be done in the receiving device 120 or remotely. A resolution provider does location resolution. Resolution providers use resolving authority records (RARs) to be identified and located. A RAR includes at least an <authority> field, corresponding to a body that creates CRIDs.

Using this process, a CRID for the content item 104 can be created which can be translated into a CRID for the sample content item 105 and a CRID for the actual content item 104. The user can then program the main CRID in the receiving device 120, or otherwise indicate his desire to obtain the content item 104, and the receiving device 120 then arranges resolution of this main CRID. In this process, the CRID for the sample content item 105 is obtained and information to this effect is presented to the user.

The content item 104 may be downloaded without restriction, but playback then requires the acquisition of rights. Often metadata regarding the content item 104 is then unconditionally available. This metadata could contain information regarding the sample content item 105, so that the user becomes aware of its existence and may want to obtain the sample content item 105 before acquiring any rights.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of providing conditional access to a content item, which content item is protected by a particular security mechanism, comprising providing unconditional access to a sample content item protected by the same particular security mechanism.

2. The method of claim 1, in which the protected content item is formatted using a particular formatting scheme, and the sample content item is formatted using the same formatting scheme.

3. The method of claim 1, in which the access to the content item is conditional upon acquisition of one or more rights.

4. The method of claim 3, in which the acquisition of said one or more rights by a client is refused until the sample content item has been accessed by said client.

5. The method of claim 3, in which the sample content item comprises an information element necessary for the acquisition of said one or more rights.

6. The method of claim 1, in which the content item is protected by an encryption scheme using a particular key, and the sample content item is protected by the same encryption scheme using the same particular key.

7. The method of claim 1, in which the sample content item comprises an advertisement or trailer for the content item.

8. The method of claim 1, in which access to the content item and the sample content item is provided using a content resolution protocol wherein the content item and the sample content item have a common content resolution identifier.

9. A sample content item associated with a content item protected by a particular security mechanism, access to the content item being conditional upon acquisition of one or more rights, the sample content item being protected by the same particular security mechanism, and comprising an information element necessary for the acquisition of said one or more rights.
